(19) United States
(12) Patent Application Publication
(10) Pub. No.: US 2025/0007090 A1
(43) Pub. Date: Jan. 2, 2025

(54) BATTERY CONTAINMENT CONSTRUCT WITH FIRE DEPARTMENT CONNECTION AND PROCESS OF INHIBITING A FIRE THEREWITH

(71) Applicant: Teijin Automotive Technologies, Inc., Auburn Hills, MI (US)

(72) Inventor: Patrick Durham, Auburn Hills, MI (US)

(73) Assignee: Teijin Automotive Technologies, Inc., Auburn Hills, MI (US)

(21) Appl. No.: 18/709,207

(22) PCT Filed: Nov. 8, 2022
(86) PCT No.: PCT/US22/49244

§ 371 Date: May 10, 2024

Related U.S. Application Data
(60) Provisional application No. 63/278,188, filed on Nov. 11, 2021.

(51) Int. Cl. H01M 50/383; A62C 3/16; H01M 50/229; H01M 50/262; H01M 50/691

(52) U.S. Cl. CPC H01M 50/383; A62C 3/16; H01M 50/229; H01M 50/262; H01M 50/691; H01M 2220/20

(57) ABSTRACT

A battery containment construct including a first housing portion, a second housing portion complimentary to the first housing portion to define a cavity therebetween, and a fastening system to join the first housing portion to the second housing portion. The cavity defined therebetween being adapted to retain a plurality of reactive metal battery cells therein. The battery containment construct further including at least one fire department connection joined to at least one of the first housing portion or the second housing portion and in fluid communication with the cavity so enable connection of a fire hose to the battery containment construct for providing a fire inhibitor to the reactive metal battery cells in order to extinguish or contain a fire.

### RELATED APPLICATIONS

This application claims priority benefit of U.S. Provisional Application Ser. No. 63/278,188, filed on Nov. 11, 2021, the contents of which are hereby incorporated by reference.

### FIELD OF THE INVENTION

The present invention in general relates to a battery containment construct, and in particular to battery containment construct with a fire department connection to provide impact resistance, fire resistance and inhibition, and fluid penetration prevention.

### BACKGROUND OF THE INVENTION

Weight savings in the automotive, transportation, aerospace, and logistics-based industries has been a major focus in order to make more fuel-efficient vehicles both for ground and air transport. In order to achieve these weight savings, light weight composite materials have been introduced to take the place of metal structural and surface body components and panels. Composite materials are materials made from two or more constituent materials with significantly different physical or chemical properties, that when combined, produce a material with characteristics different from the individual components. The individual components remain separate and distinct within the finished structure. A composite material may be preferred for reasons that include materials which are stronger, lighter, or less expensive when compared to traditional materials of steel, or aluminum. Still another advantage over metals is reduced corrosion, leading to longer operational life and reduced maintenance costs.

Composites typically have two constituent materials: matrix and reinforcement. The matrix material surrounds and supports the reinforcement materials by maintaining their relative positions. The reinforcements impart their special mechanical and physical properties to enhance the matrix properties. A synergism produces material properties unavailable from the individual constituent materials, while the wide variety of matrix and strengthening materials allows the designer of the product or structure to choose an optimum combination.

The use of fiber inclusions to strengthen a matrix is well known to the art. Well established mechanisms for the strengthening of a matrix include slowing and elongating the path of crack propagation through the matrix, as well as energy distribution associated with pulling a fiber free from the surrounding matrix material. In the context of sheet molding composition (SMC) formulations, bulk molding composition (BMC) formulations, and resin transfer molding (RTM) fiber strengthening has traditionally involved usage of chopped glass fibers, while carbon fibers are known to be high strength and low weight reinforcements.

Weight savings are particularly important for electric and hybrid vehicles powered with energy cells employing battery technologies in order to achieve greater vehicle driving range per charge. However, unique problems associated with some components of electric and hybrid vehicles have hindered the ability to use composite materials for some applications on hybrid or electric vehicles. For example, battery cells of electric and hybrid vehicles present unique safety considerations owing to the high voltages of the battery cells, chemicals employed in the battery cells, combustion and fire risks associated with the battery cells, and potential fume encounters if the battery cells are broken or damaged. The use of lithium-ion battery cells presents a unique fire risk, particularly when multiple lithium-ion battery cells are present in a single electric or hybrid vehicle. A lithium-ion battery cell fire is extremely difficult to put out and there is a high risk of spread to other lithium-ion battery cells present in an electric or hybrid vehicle, causing an uncontrollable fire. Such an uncontrollable fire is often simply let to burn itself out, resulting in the complete destruction of the vehicle. In the case of a car accident where passengers are trapped in a badly mangled vehicle, emergency responders may need time to extract the passengers. Inhibiting a lithium-ion fire to allow emergency responders sufficient time to extract trapped passengers before the fire engulfs the vehicle may be the difference between life and death. Therefore, battery cells of electric and hybrid vehicles with a fire department connection can reduce the unique risks associated with lithium-ion fires by providing a uniform connection to a source of fire inhibitor for effective and efficient fire inhibition. Additionally, battery cells of electric and hybrid vehicles generally require protective containers designed to shield battery cells from the elements and from forces they may otherwise experience during an impact or crash event. Flammability concerns have in some instances resulted in the use of heavier, yet non-combustible metal containment constructs for battery cells, such as those formed of steel, aluminum, or other metals.

Generally, such protective containers are high strength boxes formed of welded metals, which are heavy, prone to corrosion, and have been found to be water penetrable at at least the welds. Attempts have been made to form protective battery containers from composite materials to reduce the weight of such containers. However, such containers are usually joined with metal bolts, which require additional machining of through holes in the composite material of the container, placement of the bolts in the through holes, and securing of the bolts with nuts, leading to slow manufacturing throughputs and high manufacturing costs. Additionally, typical battery containment boxes formed of composite material are prone to degraded seals and failure given that the metal bolts and nuts used to join portions of the boxes together rub against and wear down the composite material near the bolt holes.

Thus, there exists a need for a battery containment construct that utilizes composite materials to lower the weight of the component, while increasing manufacturing throughput and improving the seal and performance of the battery containment construct as compared to conventional vehicle components. There further exists a need for a battery containment construct with a fire department connection that reduces the unique risks associated with lithium-ion fires by providing effective fire inhibition.

### SUMMARY

The present invention provides a battery containment construct with a fire department connection for containing and protecting battery cells that provides impact resistance, fire resistance and inhibition, and fluid penetration prevention. The battery containment construct includes a first housing portion, a second housing portion complimentary to the first housing portion to define a cavity therebetween, the cavity adapted to retain a plurality of reactive metal battery cells therein, a fastening system to join the first housing portion to the second housing portion, and a first fire department connection joined to at least one of the first housing portion or the second housing portion and in fluid communication with the cavity.

According to embodiments, the battery containment construct also has a second fire department connection joined to at least one of the first housing portion or the second housing portion and in fluid communication with the cavity. According to some inventive embodiments, the first fire department connection and the second fire department connection are on opposing sides of the first housing portion. According to other inventive embodiments, the first fire department connection and the second fire department connection are on opposing sides of the second housing portion. According to still other inventive embodiments, the first fire department connection is in the first housing portion and the second fire department connection are combined into an integrated single fitting.

According to embodiments, the housing portions are formed of a composite material such as reinforced sheet molding compound (SMC), a phenolic-SMC, epoxy, acrylonitrile butadiene styrene (ABS), polycarbonate, or random-oriented fiber reinforced thermoplastic resin (FRTP) and may be reinforced with carbon fibers, glass fibers, aramid fibers, cellulosic fibers, or a combination thereof. In still other inventive embodiments, one or more of the housing portions are formed of steel, or aluminum. According to embodiments, the battery containment construct further includes a seal around the cavity and may also include a one-way fire inhibitor exhaust valve in fluid communication with the cavity.

The present invention also provides a process of inhibiting a fire in a vehicle with a battery containment construct. The process includes connecting a first hose (not shown) in fluid communication with a fire inhibitor source to at least one of the first fire department connection or the second fire department connection, supplying the fire inhibitor from the source through the first hose into the cavity, cooling the cavity with the fire inhibitor, and inhibiting the fire. According to some inventive embodiments, a second hose (not shown) is connected to at least one of the first fire department connection or the second fire department connection. In embodiments, the second hose is in fluid communication with the fire inhibitor source. In other embodiments, the second hose drains the fire inhibitor from the cavity. In still other embodiments, the fire inhibitor is recirculated from the cavity back to the source through the second hose. According to still other inventive embodiments, the one-way fire inhibitor exhaust valve is sealed thereby containing the fire inhibitor within the cavity while in other embodiments, the one-way fire inhibitor exhaust valve is opened thereby draining the fire inhibitor from the cavity through the one-way fire inhibitor exhaust valve. In some embodiments, the fire inhibitor is at least one of water, a fire retardant, a clean agent, or an intumescent. A fire retardant may be at least one of a liquid, a foam, a gel, a powder, or a combination thereof. As used herein, a clean agent is defined as a fire suppressant substance that volatilizes so as to leave minimal residue. Exemplary clean agents operative herein include dinitrogen, argon, carbon dioxide, and some C₁-C₄ hydrofluorocarbons. According to other embodiments, at least one of the fire retardant or the intumescent is supplied through the first hose or the second hose, and the water is supplied through the other of the first hose or second hose.

### BRIEF DESCRIPTION OF THE DRAWINGS

The present invention is further detailed with respect to the following drawings that are intended to show certain aspects of the present invention but should not be construed as a limit on the practice of the present invention.

FIG. 1 is a perspective view of a battery containment construct according to embodiments of the present invention.

FIG. 2 is a bottom view of a first body portion of a battery containment construct according to embodiments of the present invention;

FIG. 3 is a cross sectional view of a portion of a battery containment construct according to embodiments of the present invention;

FIG. 4A is a bottom view of a first body portion of a battery containment construct according to embodiments of the present invention;

FIG. 4B is a top view of a second body portion of a battery containment construct according to embodiments of the present invention;

FIG. 5A is a top view of an assembled containment construct according to embodiments of the present invention;

FIG. 5B is a top view of an assembled containment construct according to embodiments of the present invention;

FIG. 5C is a top view of an assembled containment construct according to embodiments of the present invention;

FIGS. 6A-6D are side views of joiner clips according to embodiments of the present invention; and

FIG. 7 is a side view of a crimp clamp joiner clip according to embodiments of the present invention.

### DESCRIPTION OF THE INVENTION

The present invention has utility as a high strength, light weight containment construct for containing and protecting battery cells that provides impact resistance, fire resistance and inhibition, and fluid penetration prevention. The present invention has utility as a sealable battery containment construct with a fire department connection formed of composite materials that is more durable and less susceptible to wear and failure as compared to existing battery boxes and that also reduces the unique risks associated with lithium-ion fires by providing effective fire inhibition and a uniform connection a source of fire inhibitor.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below. As used in the description of the invention and the appended claims, the singular forms “a,” “an” and “the” are intended to include the plural forms as well, unless the context clearly indicates otherwise. Also as used herein, “and/or” refers to and encompasses any and all possible combinations of one or more of the associated listed items, as well as the lack of combinations when interpreted in the alternative (“or”).

As used herein “fluid penetration” refers to a single piece or joined piece construction that prevents unintended transit of gaseous or liquid coolants through a construct component in general.

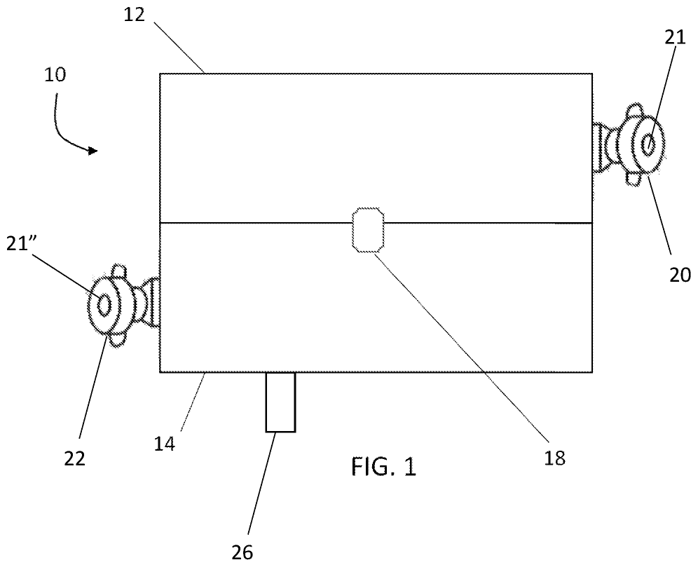

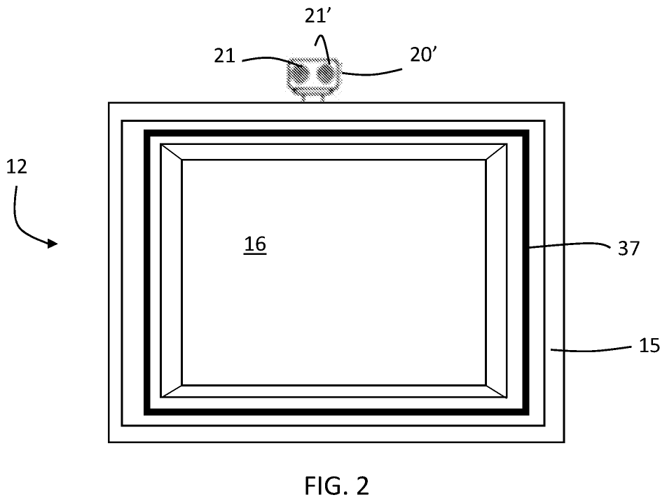

Referring now to the figures, FIGS. 1-3 show a battery containment construct 10 according to embodiments of the present invention includes a first housing portion 12, a second housing portion 14 complimentary to the first housing portion 12 to define a cavity 16 therebetween, the cavity 16 adapted to retain a plurality of reactive metal battery cells therein, a fastening system 18 to join the first housing portion 12 to the second housing portion 14, and a first fire department connection 20 having at least connector 21 joined to at least one of the first housing portion 12 or the second housing portion 14 and in fluid communication with the cavity 16. The connector 21 adapted to selectively couple with fire department hose that is able to carry a fire inhibitor through the connector 21 and into the cavity 16. It is appreciated that a first fire department connection 20 can include a second connection valve 21′ that can either be coupled to a second input fire hose or serve as an exhaust port, as best shown in FIG. 2. While the fastening system is depicted as a ribbon clip 11 in the drawings, it is appreciated that mechanical fasteners and welds are also routinely used to retain the portions 12 and 14 together or may be a toggle latch 18 as shown in FIG. 1.

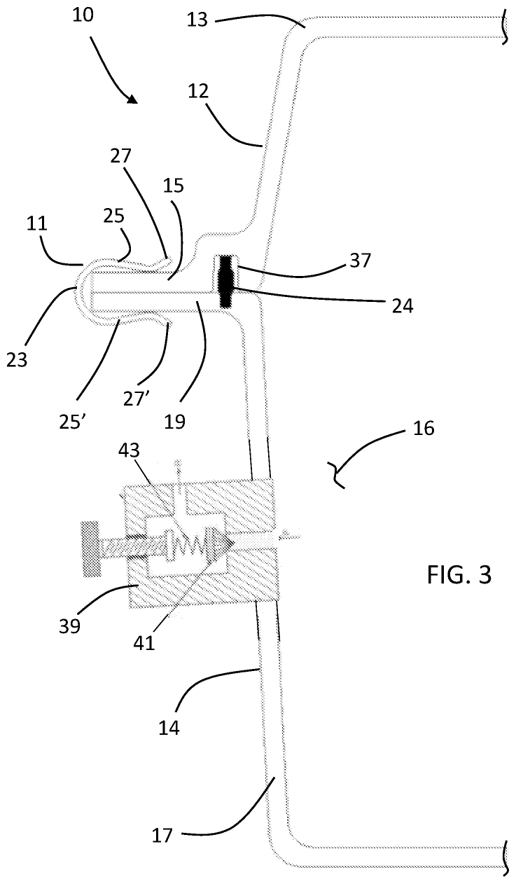

As shown in FIG. 3 the fastening system includes and a joiner clip 11 having a C-shaped cross section that joins the two housing portions 12 and 14 together. The housing portions 12, 14 and the joiner clip 11 are configured to be assembled in such a way as to form a high strength, light weight containment construct 10 that provides impact resistance, fire resistance, and fluid penetration prevention to contents contained within the construct 10, which according to embodiments is a plurality of reactive metal battery cells. In some embodiments, at least one of the plurality of reactive metal battery cells is a lithium ion cell. The containment construct 10 is particularly suitable for containing battery cells of a fuel cell, hybrid, or electric vehicle. The battery containment construct 10 protects the contents stored therein and at least partially absorbs and dissipates kinetic energy experienced during a crash or impact event. It is appreciated that typically pressures of fire department water hose outputs are approximately 1,300 kPa and if coupled to a sealed containment construct 10 will induce hydraulic rupture to create an exhaust port for substances introduced via the connection valve 21 to suppress a fire therein.

In some inventive embodiments, each housing portion 12, 14 has a body and a flange, that is, the first housing portion 12 has a first body 13 and a first flange 15 extending form the first body 13 and the second housing portion 14 has a second body 17 and a second flange 19 extending form the second body 17. The first flange 15 and the second flange 19 are configured to engage one another in abutting contact such that the first body 13 of the first housing portion 12 and the second body 17 of the second housing portion 14 define the cavity 16 therebetween. The joiner clip 11 is configured to engage the first flange 15 and the second flange 19 to join the first housing portion 12 and the second housing portion 14 together.

According to embodiments, as shown in in FIG. 1 the battery containment system includes a second fire department connection 22 having at least connector 21″ joined to at least one of the first housing portion 12 or the second housing portion 14 and is in fluid communication with the cavity 16. It is appreciated that the fire department connections 20, 22 provide a uniform connection to the cavity 16 which allows for efficient application of a fire inhibitor from a source and effective inhibition of a vehicle battery fire. In embodiments, the first fire department connection 20 and the second fire department connection 22 are on opposing sides of the first housing portion 12. In other embodiments, the first fire department connection 20 and the second fire department connection 22 are on opposing sides of the second housing portion 14. In still other inventive embodiments, the first fire department connection 20 is in the first housing portion 12, and the second fire department connection 22 is in the second housing portion 14. According to other inventive embodiments, it is appreciated that the first fire department connection 20 and the second fire department connection 22 are each in discrete fluid communication with the cavity 16—each fire department connection 20, 22 offers a separate inlet into the cavity 16.

As shown in FIG. 2, the first fire department connection has more than connector 21, 21′. This allows multiple hoses to be connected to at least one of fire department connections 20. Multiple hoses offer a variety of benefits illustratively including increasing the flow of fire inhibitor (e.g. water, fire retardant, an intumescent) into the cavity 16 and allowing for the simultaneous introduction of multiple types fire inhibitors into the cavity 16 or one of the valves 21 or 21′ to function as an exhaust port.

According to some inventive embodiments, the housing portions 12, 14 of the containment construct 10 are formed of a composite material. According to other inventive embodiments, the housing portions 12, 14 are formed of reinforced sheet molding compound (SMC), a phenolic-SMC, epoxy, acrylonitrile butadiene styrene (ABS), polycarbonate, or random-oriented fiber reinforced thermoplastic resin (FRTP). Sheet molding compound (SMC) or sheet molding composite is a ready to mold fiber-reinforced polyester material primarily used in compression molding. SMC is a reinforced composite material that is manufactured by dispersing long strands (20-60 mm) of chopped glass fibers in a matrix of polyester resin. It is appreciated that fibers with long range order are also operative herein and include woven mats, continuous fibers, or sheet forms. Thermoplastic materials operative herein amenable to functioning as a fiber matrix illustratively include: poly(methyl methacrylate) (PMMA), acrylonitrile butadiene styrene (ABS), polyamides, polylactides, polybenzimidazoles, polycarbonates, polyether sulfones, polyethylene, polypropylene, polystyrene, polyvinyl chloride, or block copolymers of any one of the aforementioned constituting the majority by monomer number. Reinforcing fibers and fillers operative herein illustratively include carbon fibers, glass fibers, aramid fibers, cellulosic fibers, or a combination thereof. In some inventive embodiments, the chopped fiber is glass fiber, alone or in combination with other types of fiber or reinforcing fillers. According to still other inventive embodiments, the housing portions 12, 14 are formed of glass or carbon fiber reinforced SMC. The housing portions are also readily formed of metals such as steel, titanium, or aluminum.

According to some inventive embodiments, a coating is readily applied to one or both of the housing portions 12, 14. The coating illustratively includes materials that impart fire resistance, are phenolic in nature, electromagnetic interference-radiofrequency interference (EMI-RFI) resistance, or a combination of such coatings. That is, according to embodiments, the housing portions 12, 14 are coated in a fire resistant, or a fire-retardant material. A fire-resistant material is one that is designed to resist burning and withstand heat and provide insulation to the substrate, while a fire-retardant material is designed to burn slowly and reduce the rate of flame spread. Intumescent fire-resistant materials work by expanding their volume from 15 to 30 times and generating an ash-like char layer that erodes as fire exposure continues. Expansion then occurs again with the number of times the process repeats itself dependent upon the thickness of the coating. For example, such fire resistant or fire retardant materials for coating the housing portions 12, 14 include any of the following: silicone, casein or vinyl resins, aluminum trihydrate or antimony oxide, ammonium polyphosphate, pentaerythritol, melamine derivatives, boric acid (H₃BO₃) and borax (Na₂B₄O₇·10H₂O), disodium octaborate tetrahydrate (Na₂B₈O₁₃·4H₂O), dicyandiamide-formaldehyde-phosphoric acid, melamine-dicyandiamide-formaldehyde-phosphoric acid, poly(n-vinylpyrolidone), colloidal silica, magnesium hydroxide (MDH), monoammonium phosphate (MAP), aluminum hydroxide (ATH), carbonates and hydrogen carbonates, potassium carbonate, Na₂WO₄, Na₂SnO₃, Na₂MoO₄, ammonium polyphosphate, pentaerythritol, melamine, expandable graphite, or combinations thereof. Phenolic resins operative herein illustratively includes epoxy phenolic resins, and phenol formaldehyde resins that impart corrosion resistance and a mar resistance surface relative to the underlying substrate of the construct 10. EMI-RFI shielding coatings operative herein illustratively include nickel coated glass mat; carbon fiber matting; copper or nickel paint; various metal foils, such as aluminum, nickel, iron, copper, and alloys thereof; and or combinations thereof with the proviso that the EMI-RFI shielding is grounded so as to function as a Faraday cage.

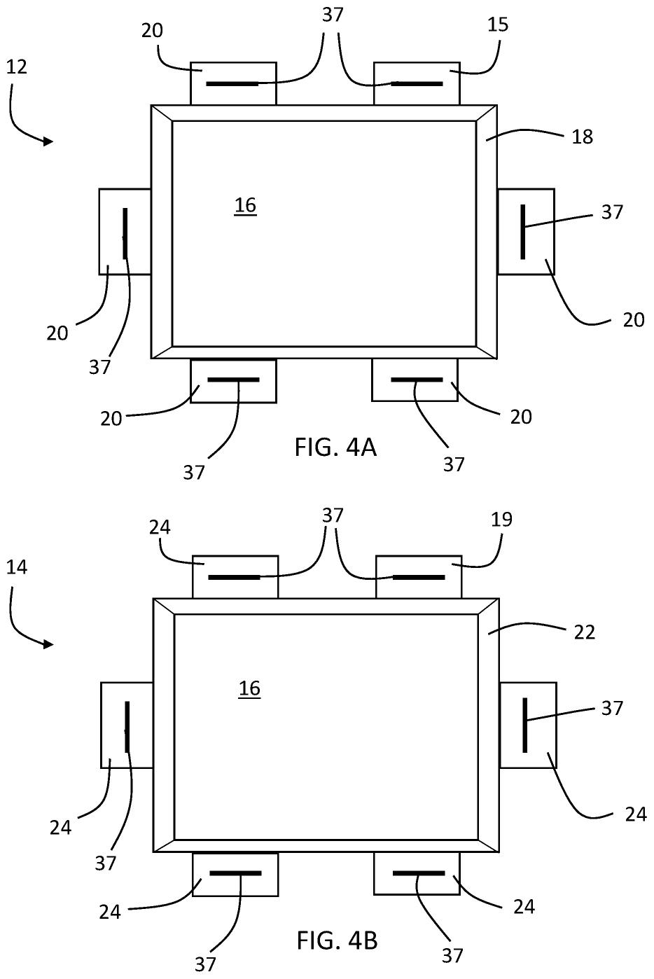

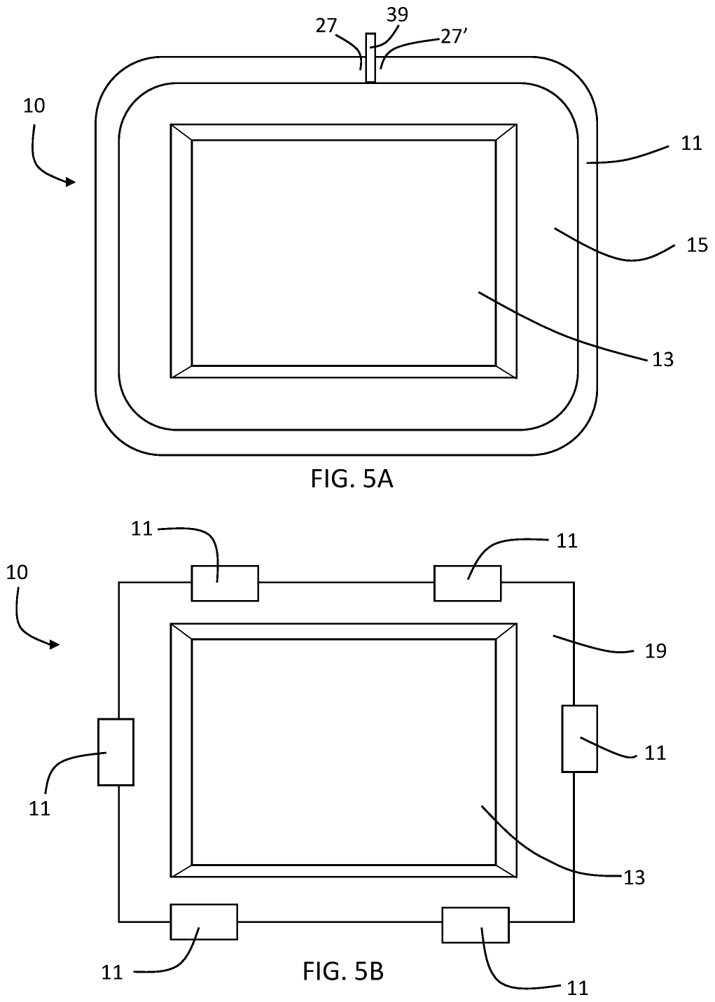

According to embodiments, the first flange 15 surrounds the perimeter of the first housing portion 12. Similarly, according to embodiments, the second flange 19 surrounds the perimeter of the second housing portion 14. According to embodiments, such as those shown in FIGS. 2, 5A, and 5B, the flanges 15, 19 are each continuous in that they entirely cover the perimeter of the respective housing portions 12, 14. According to other embodiments, such as those shown in FIGS. 4A, 4B, and 5C, the flanges 15, 19 are each made up of separate and discrete flange portions that non-continuously surround the respective housing portions 12, 14. According to embodiments, in which the flanges 15, 19 are continuous and entirely surround the housing portions 12, 14, the joiner clip 11 is either a single continuous joiner clip, as shown in FIG. 5A, that also entirely surrounds the housing portions 12, 14, or the joiner clip 11 is a plurality of separate and discrete joiner clips, as shown in FIG. 5B, positioned at separate locations along the first flange 15 and the second flange 19 to non-continuously surround the housing portions 12, 14. According to embodiments, in which the flanges 15, 19 are each made up of separate and discrete flange portions that non-continuously surround the respective housing portions 12, 14, the joiner clip 11 is a plurality of separate and discrete joiner clips positioned at separate locations along the first flange 15 and the second flange 19 to non-continuously surround the housing portions 12, 14, as shown in FIG. 5C.

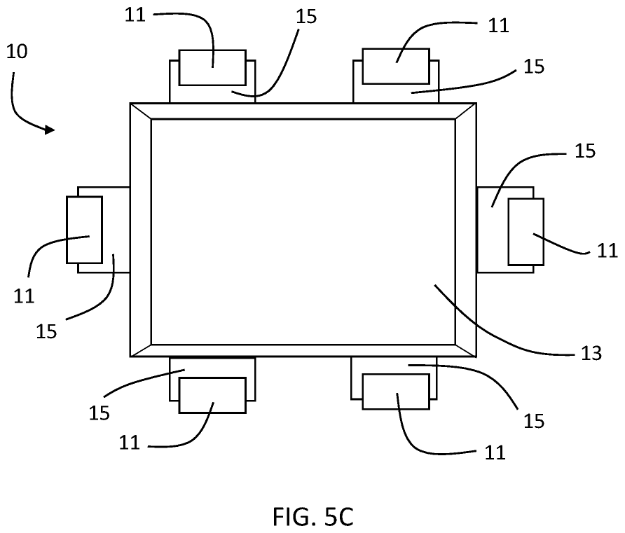

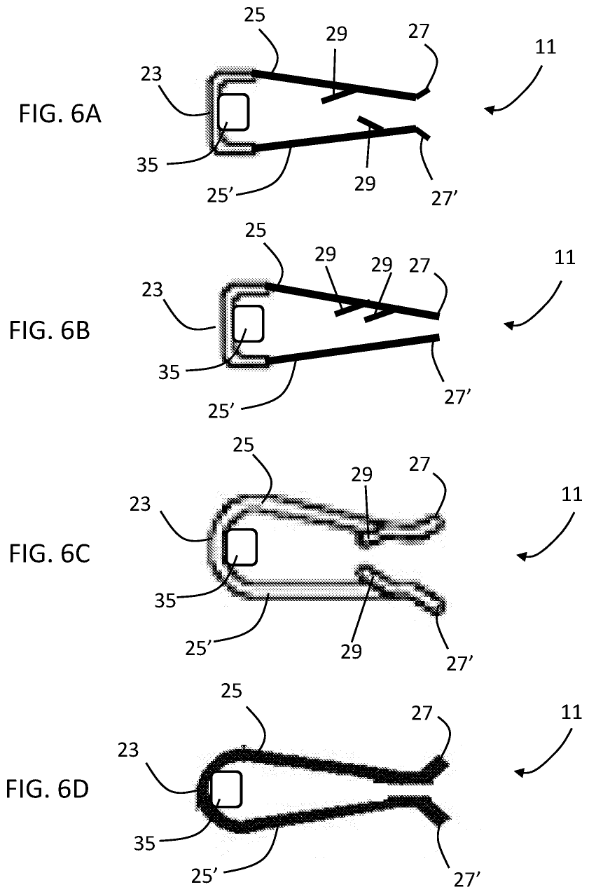

According to embodiments, such as those shown in FIGS. 3 and 6A-6D, the joiner clip 11 includes a base section 23 and a pair of jaws 25, 25′ extending from the base section 23 each jaw 25, 25′ of the pair of jaws having a free end 27, 27′, respectively. According to embodiments, the base section 23 is curved or square, as shown in FIGS. 6C-6D and 6A-6B, respectively. According to embodiments, one or both of the jaws 25, 25′ are straight or feature a curve such that the free ends 27, 27′ of each of the jaws 25, 25′ are flared away from one another, such as shown in FIGS. 6A and 6C-6D and 6B, respectively. The flared free ends 27, 27′ facilitate easy application of the joiner clip 11 onto the flanges 15, 19. That is, to apply the joiner clip 11, the flanges 15, 19 are positioned between the free ends 27, 27′ of the joiner clip 11 and the joiner clip 11 is pushed or pounded onto the flanges 15, 19, thereby eliminating the need for a special tool for separating the jaws 25, 25′. The flared free ends 27, 27′ also reduce wear on the composite material of the flanges 15, 19 by ensuring that the free ends 27, 27′ do not rub on the flanges 15, 19.

According to embodiments, the free ends 27, 27′ of each of the jaws 25, 25′ are biased toward one another. Thus, when the joiner clip 11 is engaged with the flanges 15, 19, such that the flanges 15, 19 are positioned between the jaws 25, 25′ of the joiner clip 11, the joiner clip 11 applies a compressive force to the first flange 15 and the second flange 19 to join the first housing portion 12 and second housing portion 14 together. According to embodiments, the joiner clip 11 is formed of a metal, such as spring steel, a thermoplastic, or an elastomeric material. Embodiments in which the joiner clip is formed of an elastomeric material provide the additional benefit of sealing the portions of the housing 12, 14 while also joining them together. According to embodiments, the joiner clip 11 also includes at least one barb 29 positioned on an inner surface of at least one of the jaws 25, 25′. The barb or barbs 29 are configured to dig into the composite material of the flanges 15, 19 or may engage with a groove 31 formed in the flanges to prevent the joiner clip 11 from falling off of or being easily removed from the flanges 15, 19.

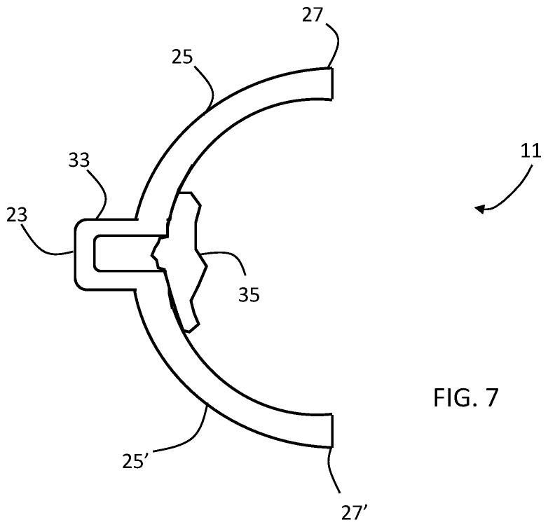

According to embodiments, the joiner clip 11 is a crimp clamp, such as that shown in FIG. 7. The crimp clamp joiner clip 11 includes a base section 23 and a pair of jaws 25, 25′ extending from the base 23 section of each jaw 25, 25′ of the pair of jaws having a free end 27, 27′, respectively. According to embodiments, the base section 23 includes an ear section 33, as shown in FIG. 7. According to embodiments, the jaws 25, 25′ curve out from the ear section 33 such that the crimp clamp joiner clip 11 forms a semi-circle with the free ends 27, 27′ of each of the jaws 25, 25′ spaced apart from one another. According to embodiments, the crimp clamp joiner clip 11 is formed for a metal, thermoplastic, or elastomeric material that is deformable yet resilient even after deformation. To apply the crimp clamp joiner clip 11, the flanges 15, 19 are positioned between the free ends 27, 27′ of the non-deformed crimp clamp joiner clip 11, that is in its semi-circular configuration. Next, the free ends 27, 27′ of the crimp clamp joiner clip 11 are pinched or crimped into contact with the flanges 15, 19. According to embodiments, the free ends 27, 27′ of the crimp clamp joiner clip 11 are pinched or crimped using an automated system that by way of non-limiting example includes rollers that apply a compressive force to the free ends 27, 27′ of the crimp clamp joiner clip 11. Thus, when the crimp clamp joiner clip 11 is deformed into clamped engagement with the flanges 15, 19, such that the flanges 15, 19 are positioned between the deformed jaws 25, 25′ of the joiner clip 11, the joiner clip 11 applies a compressive force to the first flange 15 and the second flange 19 to join the first housing portion 12 and second housing portion 14 together. It will be understood that use of such a joiner clip 11 allows the length of the flanges 15, 19, that is the distance the flanges 15, 19 extend from the body portions 13, 17, to be shortened. Accordingly, the overall weight and size of the containment construct 10 is reduced, particularly compared to a containment construct that uses fasteners such as bolts to join the portions of the housing.

According to embodiments, the joiner clip 11 includes a gasket material 35 positioned near the base 23 of the joiner clip 11. The gasket material 35 is compressed into a sealed configuration upon contact with the first flange 15 and second flange 19 and acts to seal the portions of the housing 12, 14 in watertight and airtight engagement. According to embodiments, the gasket material 35 is attached to the joiner clip 11, while in other embodiments, the gasket material 35 is a separate piece of material that is simply placed within the joiner clip 11 prior to installation on the flanges 15, 19.

According to embodiments, the containment construct 10 also includes a seal 24 around the cavity 16. According to embodiments, the seal 24 acts as a connector between the first housing portion 12 and the second housing portion 14 to limit movement or slippage between the first housing portion 12 and the second housing portion 14. According to embodiments, the seal 24 is any of an adhesive, a gasket, or silicone. In some embodiments the seal 24 is a connector positioned between the first flange 15 and the second flange 19. In other embodiments, such as that shown in FIG. 3, at least one of the first flange 15 and second flange 19 define a channel 37 that is configured to receive and retain the seal 24. The channel 37 may be a continuous channel or may be a plurality of discrete channels spaced along the length of at least one of the flanges 15, 19 at spaced apart positions. According to embodiments, the channel 37 is formed in at least one of the flanges 15, 19 when the housing portions 12, 14 are formed or molded, or may be subsequently cut, drilled, or stamped into the at least one flange 15, 19. According to embodiments in which at least one of the flanges 15, 19 includes a channel 37, the seal 24 is placed in the channel 37 before the flanges 15, 19 are brought into contact with one another. According to embodiments, in which both flanges 15, 19 define a channel 37 therein, the seal 24 is placed in the channel 37 of for example the first flange 15 and then the second flange 19 is brought into contact with the first flange 15 and the seal 24. In such embodiments, the seal 24 can be used as a position locator for ensuring that the first flange 15 and second flange 19 are properly positioned relative to one another. Additionally, once assembled, the seal 24 ensures that the first housing portion 12 and the second housing portion 14 remain properly positioned relative to one another during use, by preventing slippage, which in turn reduces wear on the parts. It will also be understood that when the seal 24 is a gasket, the barrier material may act to seal the portions of the housing 12, 14 in watertight engagement and act to locate and retains the position of the housing portions 12, 14 relative to one another.

According to embodiments, as shown in FIG. 1, the containment construct 10 additionally includes a one-way inhibitor exhaust valve 26 in fluid communication with the cavity 16. In other embodiments, the containment construct 10 includes a pressure relief valve 39 which acts to vent pressure that may build up within the cavity 16, for example due to fire within the cavity 16 or some other failure of the contents contained within the containment construct 10 that result in a pressure build up. According to embodiments, the pressure relief valve 39 is positioned through at least one of the housing portions 12, 14. According to embodiments, the pressure relief valve 39 is threaded or otherwise secured within a hole that is formed in the at least one housing portion 12, 14. Such a hole for the pressure relief valve 39 may be formed in at least one of the housing portions 12, 14 when it is formed or molded, or may be subsequently cut, drilled, or stamped into the at least one of the housing portions 12, 14. According to embodiments, the pressure relief valve 39 is positioned between the flanges 15, 19 between the ends 27, 27′ of the joiner clip 11, such as shown in FIG. 5A. According to embodiments, the pressure relief valve 39 includes a valve element 41 that is held in a closed position by a spring 43 until the pressure build up within the cavity 16 overcomes the force of the spring 43 at which point the pressure forces the valve element 41 open so the pressure build up may escape.

According to certain inventive embodiments, at least one of the housing portions 12, 14 includes internal divider walls internally, which divide the cavity 16 into sections of sub-cavities. The internal divider walls provide additional structural rigidity to the battery containment construct 10 and provide support to battery cells positioned within the containment construct 10 to limit shifting of the battery cells within the containment construct. According to embodiments, at least one of the housing portions 12, 14 includes a through hole defined in at a wall of the body. The through hole allows a wire or cable to be passed therethrough, such as a high voltage wire for connecting the battery cells contained within the battery containment construct 10 to the other systems of the hybrid or electric vehicle systems.

According to certain inventive embodiments, a containment construct 10 has dimensions suitable to contain battery cells of an electric or hybrid vehicle. For example, embodiments of the inventive battery containment construct are a height of 100 to 500 mm, a length of 100 to 5000 mm, and a width of 100 to 3000 mm. According to embodiments, multiple layers of battery cells are stacked within the containment construct 10, resulting in taller containment constructs. According to embodiments, multiple layers of containment constructs 10 are stacked.

A process of inhibiting a fire in a vehicle with the inventive battery containment construct 10 is also provided and includes connecting a first hose in fluid communication with a fire inhibitor source to at least one of the first fire department connection 20 or the second fire department connection 22, supplying a fire inhibitor from the source through the first hose into the cavity 16, allowing sufficient time for the fire inhibitor to cool the cavity 16, and inhibiting the fire. According to embodiments, the inventive process includes connecting a second hose to at least one of the first fire department connection 20 or the second fire department connection 22. In embodiments, the second hose is in fluid communication with the fire inhibitor source. It is appreciated that the fire inhibitor source illustratively includes a fire hydrant, a fire truck, and a liquid tanker. In some embodiments, the inventive process includes draining the fire inhibitor from the cavity 16 through the second hose. It is appreciated that when there is access to an unlimited supply of fire inhibitor, continuously flowing the fire inhibitor into the cavity 16 and draining it out of the cavity 16 moderates the temperature of the vehicle fire, absorbing the heat from the vehicle fire, thereby slowing the spread of the fire, and reducing the chances that adjacent battery cells catch fire. In other embodiments, the inventive process includes recirculating the fire inhibitor from the cavity 16 back to the source through the second hose. It is appreciated that when an unlimited supply of fire inhibitor is unavailable, recirculating the fire inhibitor into the cavity and back to the source ensures a constant flow of fire inhibitor into the fire. The fire inhibitor absorbs heat from the fire during each pass into the fire. However, the inventive recirculation cools the fire inhibitor and dissipates kinetic energy after each pass into the fire as it is recycled back to the source. In still other embodiments, the inventive process includes sealing the one-way fire inhibitor exhaust valve 26 and containing the fire inhibitor within the cavity 1, while in other embodiments the one-way fire inhibitor exhaust valve 26 is opened to drain the fire inhibitor from the cavity 16 through the one-way fire inhibitor exhaust valve 26. As noted above, draining the fire inhibitor is best suited for situations where there is access to a limitless supply of fire inhibitor. When there is not access to an unlimited supply of fire inhibitor, nor is there an ability to recirculate the fire inhibitor back to the source, it is appreciated that sealing the fire inhibitor inside the cavity 16 also serves to absorb heat from the fire, keeping the temperature moderated to slow the spread of the fire to adjacent battery cells. According to embodiments, the fire inhibitor is at least one of water, a fire retardant, or an intumescent. According to other embodiments, fire retardant is present and is at least one of a foam or a gel. It is appreciated that the fire retardant foam not only absorbs heat and dissipates kinetic energy, it is also a poor thermal conductor due to gases included in the fire retardant foam. It is further appreciated that the fire retardant foam decreases the available air supply in the cavity 16, further enhancing its fire inhibition properties. It is still further appreciated that the intumescent expands in volume upon exposure to heat which enhances its heat absorption effectiveness. In embodiments, the inventive process includes supplying at least of a fire retardant or an intumescent through the first hose or the second hose and supplying water through the other of the first hose or the second hose.

According to some inventive embodiments, the fire department connection 20 is additionally or alternatively provided in connection with a temperature regulation system of the battery cell system of the vehicle. A temperature regulation system for a battery cell system of a vehicle may include a cooling manifold that circulates air or a liquid coolant around the battery cells of the vehicle during normal operation in order to maintain the battery cells within a desired temperature range that corresponds to preferred operating conditions. Such a system may include a network of conduits that are designed so that the air or liquid coolant is able to circulate around the battery cells without coming into direct contact with the battery cells. According to such embodiments of the present invention, the fire department connection 20 is provided in connection with such a temperature regulation system so that a fire department hose that is connected to the fire department connection 20 is able to provide a fire inhibitor directly to the existing temperature regulation system of the battery cell system of the vehicle and accordingly circulate the fire inhibitor within the already existing network of conduits of the temperature regulation system in order to moderate the temperature of the vehicle fire, absorbing the heat from the vehicle fire, thereby slowing the spread of the fire, and reducing the chances that adjacent battery cells catch fire.

The present invention is further detailed with respect to the following non-limiting examples. These examples are exemplary of specific embodiments of the present invention and not intended to limit the scope of the appended claims.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. A battery containment construct comprising:
a first housing portion;
a second housing portion complimentary to said first housing portion to define a cavity therebetween, the cavity adapted to retain a plurality of reactive metal battery cells therein;
a fastening system to join said first housing portion to said second housing portion; and
a first fire department connection joined to at least one of said first housing portion or said second housing portion and in fluid communication with the cavity.

2. The battery containment construct of claim 1 further comprising a second fire department connection joined to at least one of said first housing portion or said second housing portion and in fluid communication with the cavity.

3. The battery containment construct of claim 2 wherein said first fire department connection and said second fire department connection are on opposing sides of said first housing portion.

4. The battery containment construct of claim 2 wherein said first fire department connection and said second fire department connection are on opposing sides of said second housing portion.

5. The battery containment construct of claim 2 wherein said first fire department connection is in said first housing portion and said second fire department connection is in said second housing portion.

6. The battery containment construct of claim 1 wherein said first housing portion and said second housing portion are formed of a metal or a composite material.

7. The battery containment construct of claim 6 wherein the composite material present and is any one of: reinforced sheet molding compound (SMC), a phenolic-SMC, epoxy, acrylonitrile butadiene styrene (ABS), polycarbonate, or random-oriented fiber reinforced thermoplastic resin (FRTP).

8. The battery containment construct of claim 6 wherein the composite material is reinforced with carbon fibers, glass fibers, aramid fibers, cellulosic fibers, or a combination thereof.

9. The battery containment construct of claim 1 further comprising a seal around the cavity.

10. The battery containment construct of claim 1 further comprising a one-way fire inhibitor exhaust valve in fluid communication with the cavity.

11. The battery containment construct of claim 1 wherein said first fire department connection has more than one connector.

12. A process of inhibiting a fire in a vehicle with a battery containment construct of claim 1 comprising:
connecting a first hose in fluid communication with a fire inhibitor source to at least one of said first fire department connection or a second fire department connection;
supplying a fire inhibitor from said fire inhibitor source through said first hose into the cavity;
allowing sufficient time for said fire inhibitor to cool the cavity to inhibit the fire.

13. The process of claim 12 further comprising connecting a second hose to at least one of said first fire department connection or said second fire department connection.

14. The process of claim 13 wherein said second hose is in fluid communication with said fire inhibitor source.

15. The process of claim 13 further comprising draining said fire inhibitor from the cavity through said second hose.

16. The process of claim 13 further comprising recirculating said fire inhibitor from the cavity back to said fire inhibitor source through said second hose.

17. The process of claim 12 further comprising sealing a one-way fire inhibitor exhaust valve and containing the fire inhibitor within the cavity.

18. The process of claim 17 further comprising opening said one-way fire inhibitor exhaust valve and draining said fire inhibitor through said one-way fire inhibitor exhaust valve.

19. (canceled)

20. The process of claim 12 wherein said fire retardant is present and is at least one of a liquid, a foam, a gel, or a powder.

21. The process of claim 12 further comprising supplying at least one of a fire retardant or an intumescent through said first hose and supplying water through a second hose.
